(19) United States
(12) Patent Application Publication
(10) Pub. No.: US 2001/0055206 A1
(43) Pub. Date: Dec. 27, 2001

(54) Lightning fixture for showing roadway diversion

(76) Inventors: Chon-Hua Liao, Taoyuan (TW); Chih-Chieh Lin, Kuei-Shan Hsiang (TW)

Correspondence Address: J.C. Patents, Inc., 4 VENTURA, SUITE 250, Irvine, CA, 92618, US

(21) Appl. No.: 09/729,146

(22) Filed: Dec. 1, 2000

(30) Foreign Application Priority Data
Jun. 26, 2000 (TW) 89210935

(51) Int. Cl. F21L 4/08

(52) U.S. Cl. 362/183; 362/153.1; 362/184; 362/231; 362/800

(57) ABSTRACT

A roadway diversion lighting fixture. The lighting fixture includes a casing, a solar panel for receiving sunlight and a light-emitting source capable of producing flashes. The lighting fixture can provide illumination all day and can operate in all kinds of weather conditions. The lighting fixture is easy to mount and operate. Moreover, there is no need to replace battery regularly or to lay down power cable. The casing is painted to prevent rusting, the accumulation of dust and infiltration by water.

### CROSS-REFERENCE TO RELATED APPLICATION

This application claims the priority benefit of Taiwan application serial no. 89210935, filed Jun. 26, 2000.

### BACKGROUND OF THE INVENTION

1. Field of Invention

The present invention relates to roadway warning light. More particularly, the present invention relates to a set of light fixture for showing roadway diversion.

2. Description of Related Art

Due to rapid commercialization of society, motorized vehicles have become an indispensable means for people to move around from place to place performing different kinds of activities. Hence, road safety is a very important issue for the public. In general, people driving a motorized vehicle needs to follow road signs and light signals to progress or stop. Partitioned roadways often have lights or signs put in the middle of separate roadways to show the forward direction. These roadway lighting fixtures fall into two main categories. One type employs a multiple of reflecting plates that serve to give warning to drivers about the road conditions ahead, especially during bad weather. The other type of fixtures uses battery to power a lamp. However, this type of lighting fixture not only demands considerable power but also requires long length of electrical supply lines.

FIG. 1A is a sketch of a conventional roadside diversion fixture that employs a light reflector. The fixture with the light reflector at the top is implanted in the middle of a roadway. The fixture has no light source. Hence, light will appear to a driver only when the headlight of the driver's car or some other cars ahead or behind happens to fall on the reflecting plate. Typically, the maximum visual distance on a clear day is only about 15 meters. In general, the further away, the weaker is the back reflection and corresponding warning effect. Furthermore, if the headlight of a car is weak or the weather condition is bad such as rainy, snowy or foggy, the warning effect is even weaker.

FIG. 1B is a sketch of a conventional road diversion indicator lighting fixture. The lamp within the lighting fixture is powered by electrical supply lines or self-contained battery packs. However, everybody knows that conventional lamp is a power hungry device. Once the battery power is low, maintenance peoples have to replace the battery on site, thereby wasting considerable manpower. Similarly, lighting fixture powered by electrical lines requires cable laying and routine maintenance. Since the lamps can operate for a limited period, a team of maintenance workers has to get around to check battery power level from time to time. In a time when environmental protection and the use of reusable energy resource are of utmost importance, this type of roadway lighting fixture is highly inefficient and environmentally unfriendly.

In brief, the two most common conventional fixtures for roadway diversion indication have some drawbacks. Fixtures that employ reflection panel suffer from insufficient brightness level and short operable distance. Moreover, bad weather often results in poor visibility condition. On the other hand, lighting fixture with battery or electrical power line driven lamps suffer from the need for routine maintenance such as battery renewal, light bulb replacement, thereby increasing the cost of operation.

### SUMMARY OF THE INVENTION

Accordingly, one object of the present invention is to provide a roadway diversion lighting fixture that not only performs better than a conventional roadside fixture, but is also less affected by changing atmospheric conditions.

A second object of this invention is to provide a roadway diversion lighting fixture that improves upon the conventional light reflector design. In the convention reflector design, light is emitted only when a beam of light of sufficient strength impinges upon the reflector plates. Since brightness level of the reflector is difficult to ensure and the reflector may operate only within a very short distance, a driver may misjudge the distance or escape attention altogether.

A third object of this invention is to provide a roadway diversion lighting fixture that avoids routine maintenance including periodic battery renewal, laying of electrical power cable and light bulb replacement, thereby reducing cost of operation considerably.

A fourth object of this invention is to provide a roadway diversion lighting fixture that can be easily installed and instantly used. Furthermore, the lighting fixture has an outer casing protected by an anti-rusting, water-resistant, dust-resistant paint, water-resistant paint.

To achieve these and other advantages and in accordance with the purpose of the invention, as embodied and broadly described herein, the invention provides a roadway diversion lighting fixture. The lighting fixture includes a rectangular casing having a sealed end and an open end. A plurality of bright light emitting diodes is flushed on the rectangular casing. The lighting fixture also includes a solar panel coupled to the sealed end of the rectangular panel. The solar panel can pick up sunlight and transform sunlight into useful electrical energy for battery charging.

This invention also provides a roadway diversion lighting fixture that includes a light-emitting device. An electrical energy storage unit is electrically connected to the light-emitting device to provide the power necessary for lighting up the device. The lighting fixture also includes an energy absorption and conversion unit coupled to the electrical energy storage unit. The energy absorption and conversion unit is responsible for capturing natural energy and converting the energy into useful electrical energy. The electrical energy is stored inside the electrical energy storage device.

Because an energy absorption and conversion unit such as a solar panel is employed in the invention, neither the lay down of long stretch of electrical supply cable nor regular battery replacement is necessary. In addition, the use of bright light-emitting diodes extends visibility of roadway diversion considerably.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a sketch of a conventional roadside diversion fixture that employs a light reflector;

FIG. 1B is a sketch of a conventional road diversion indicator lighting fixture;

FIG. 2 is a block diagram showing the operating units of a roadway diversion lighting fixture according to one preferred embodiment of this invention;

FIG. 3 is a diagram showing the circuit of the roadway diversion lighting fixture according to this invention; and

FIG. 4 is a perspective view showing the external appearance of the roadway diversion lighting fixture according to this invention.

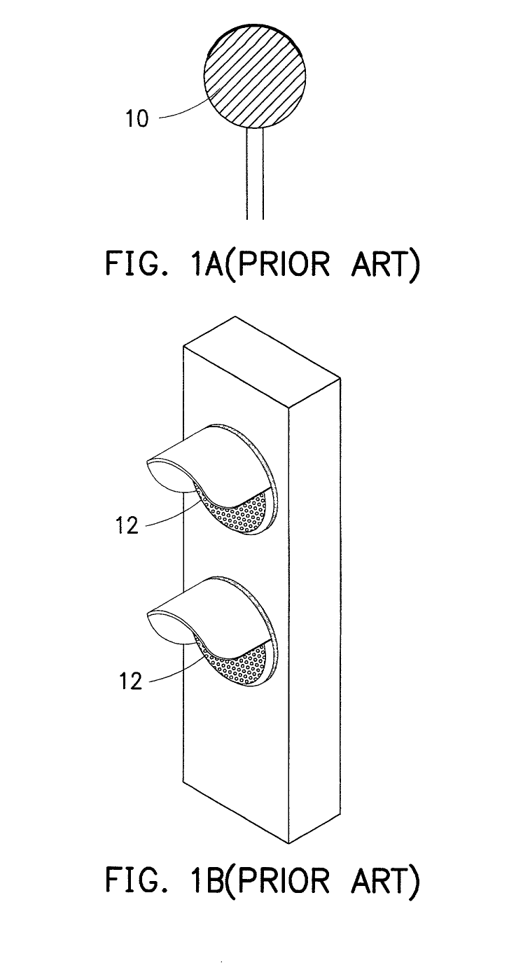

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

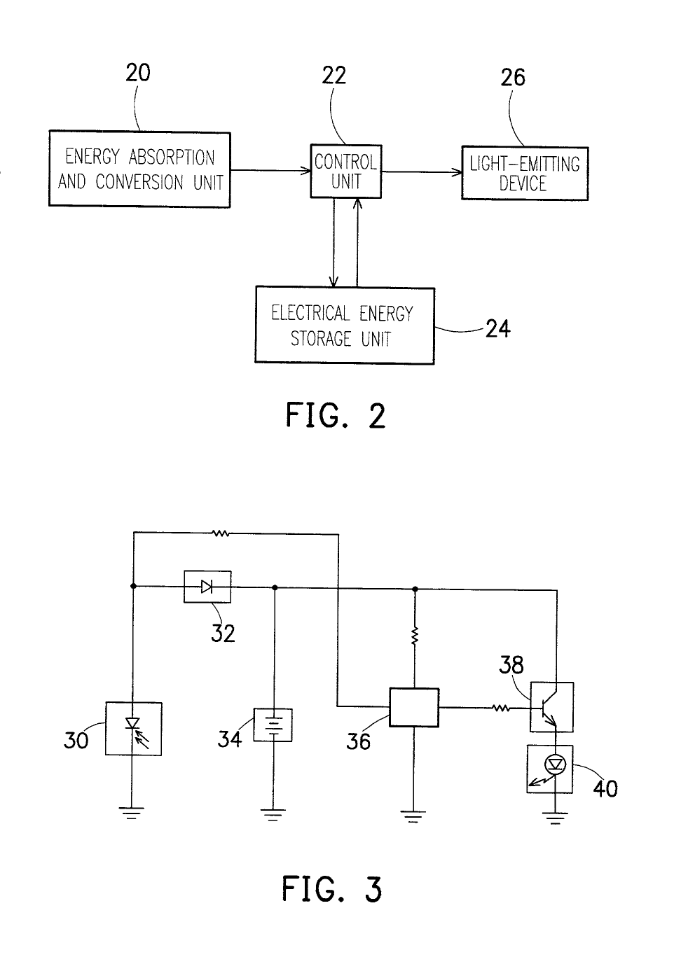

FIG. 2 is a block diagram showing the operating units of a roadway diversion lighting fixture according to one preferred embodiment of this invention. As shown in FIG. 2, the lighting fixture includes an energy absorption and conversion unit 20 such as a solar panel, an electrical energy storage unit 24 such as a battery, a control unit 22 such as a control circuit and a light-emitting device 26 such as a panel of light-emitting diodes. The energy absorption and conversion unit 20 is capable of absorbing natural power resources and converting the energy resource into electrical energy. Under the supervision of the control unit 22, the electrical energy is transferred and stored inside the electrical energy storage unit 24. The control unit 22 is also responsible for controlling the supply of electrical energy from the electrical energy storage unit 24 to the light-emitting device 26 as well as switching the light-emitting devices 26 on or off.

FIG. 3 is a diagram showing the circuit of the roadway diversion lighting fixture according to this invention. As shown in FIG. 3, the electrical circuit includes a solar panel 30, a storage battery 34, a control chip 36, a light-emitting diode 40, a diode 32 and a junction transistor 38. The solar panel 30 absorbs sun's ray and converts solar energy into electrical energy. The electrical energy is transferred to the storage battery 34. The diode 32 prevents the flow of electrical current from the storage battery 34 back to the solar panel. A signal will send to the control chip 36 when the solar panel is not operating (due to insufficient sunlight). The control chip 36 will send a signal to the junction transistor 38 and switch on the junction transistor 38 so that the storage battery 34 can provide the necessary power to drive the light-emitting diode 40. In this way, the control chip 36 controls the opening and closing of the junction transistor 38 so that the light-emitting diode 40 is turned on or off according to brightness level.

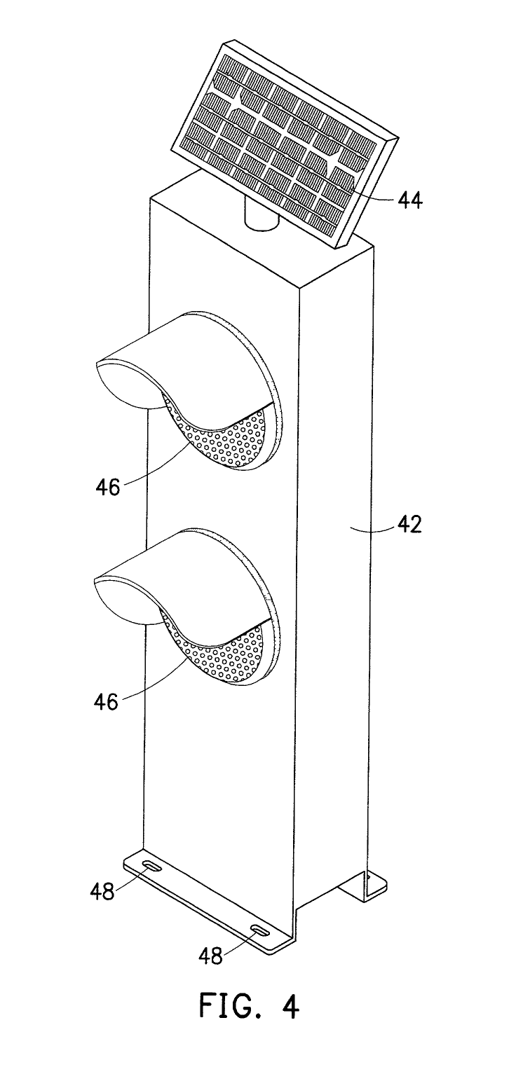

FIG. 4 is a perspective view showing the external appearance of the roadway diversion lighting fixture according to this invention. As shown in FIG. 4, the roadway diversion lighting fixture of this invention includes a steel casing 42, a light-emitting source 46 and a solar panel 44. The lighting fixture can be erected inside a tunnel, on a traffic island and at the tip section of a road diversion. The steel casing 42 is a rectangular box-like structure having a sealed top end and an open bottom end. In general, the surface of the casing 42 is covered by a layer of yellow rust proof, water and dust resistant paint. The solar panel 44 is positioned at an angle with the horizontal for easy capturing of sunlight or car light. Captured solar or light energy is converted into electrical energy and stored inside a large capacity storage battery that can provide energy to light up the light-emitting source 46 for more than 24 hours. The solar panel 44 is preferably of the type capable of generating electrical current even under snowy or cloudy condition. The light source 46 is an assembly of about 240 bright light-emitting diodes (LEDs). Unlike conventional light reflector, the light-emitting diodes are powered by electricity. Hence, visibility can be as high as 300 meters. Moreover, the light-emitting diodes have great penetrating power so that driver may clearly see the road condition in total darkness and in rainy or foggy days. In addition, the LEDs may be set in a flashing mode to attract attention. Since light emitted by the LEDs is collimated, drivers and pedestrians alike are less likely to be interfered as in conventional diffused lighting fixture. Furthermore, LED has low power consumption and very long working life. Hence, the cost due to routine maintenance work such as bulb and battery replacement can be reduced considerably. Moreover, the locking holes 48 on the front and back side near the bottom section of the casing 42 can be utilized to mount the lighting fixture. Therefore, the lighting fixture is easy to install and convenient to operate.

In summary, the advantages of the roadway diversion lighting fixture of this invention includes:

1. The roadway diversion lighting fixture uses an assembly of light-emitting diodes, which is brighter than a conventional light bulb. Solar panel is used to charge up the storage battery. Hence, the lighting fixture is operable in all kinds of weather conditions. Moreover, the LEDs can be set to flash for an improved performance.

2. The lighting fixture is self-illuminated and the light is more collimated. Unlike a conventional reflector whose brightness level depends on incoming light, standard brightness level can be maintained for the lighting fixture of this invention.

3. The energy resource is unlimited and there is no need to replace battery regularly. In addition, light-emitting diodes have long working life and hence there is no need to replace light bulbs regularly. Furthermore, the lighting fixture is self-contained and hence there is no need to lay down power supply lines. In other words, routine maintenance work is kept to a minimum, thereby saving operation cost.

4. The lighting fixture has a steel casing protected by a rust proof, water and dust resistant paint. The light fixture also has holes for easy mounting. Therefore, the fixture is easy to install and convenient to operate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A roadway diversion lighting fixture, comprising:
a rectangular casing having a sealed end and an open end;
a light-emitting source constructed from a plurality of light-emitting diodes flush-mounted onto the rectangular casing; and
a solar panel for receiving sunlight, wherein the solar panel is attached to the sealed end of the rectangular casing and is electrically coupled to the light-emitting source.

2. The lighting fixture of claim 1, wherein the rectangular casing is constructed from steel sheets.

3. The lighting fixture of claim 1, wherein the light-emitting diodes have yellow color.

4. The lighting fixture of claim 1, wherein the light-emitting diodes have red color.

5. The lighting fixture of claim 1, wherein the solar panel is positioned to form an angle with the horizontal.

6. The lighting fixture of claim 1, wherein the light-emitting assembly further includes a transparent polycarbonate (PC) plate.

7. The lighting fixture of claim 1, wherein the rectangular casing is painted.

8. A roadway diversion lighting fixture, comprising:
a light-emitting device;
an electrical energy storage unit coupled to the light-emitting device, wherein the electrical energy storage unit is a component that supplies necessary energy for powering the light-emitting device; and
an energy absorption and conversion unit coupled to the electrical energy storage unit, wherein the energy absorption and conversion unit is responsible for absorbing natural energy resources and converting the natural energy into electrical energy, and then storing the electrical energy inside the electrical energy storage unit.

9. The lighting fixture of claim 8, wherein the light-emitting device includes light-emitting diode (LED).

10. The lighting fixture of claim 8, wherein the electrical energy storage unit includes a storage battery.

11. The lighting fixture of claim 8, wherein the energy absorption and conversion unit includes a solar panel.

12. The lighting fixture of claim 8, wherein the fixture further includes a control unit that couples with the light-emitting device, the electrical energy storage unit and the energy absorption and conversion unit, and the control unit is responsible for turning the light-emitting device on or off under appropriate conditions.

13. The lighting fixture of claim 12, wherein the control unit further includes a control circuit.
